(19) United States
(12) Patent Application Publication
(10) Pub. No.: US 2012/0070233 A1
(43) Pub. Date: Mar. 22, 2012

(54) FOUNDATION FOR WIND TURBINE GENERATOR

(75) Inventors: Shin-Tower Wang, Austin, TX (US); William M. Isenhower, Austin, TX (US); Jose A. Arrellaga, Austin, TX (US); Luis Vasquez, Austin, TX (US); Joseph O. Stevens, San Diego, CA (US)

(73) Assignee: Ensoft, Inc., Austin, TX (US)

(21) Appl. No.: 12/944,408

(22) Filed: Nov. 11, 2010

Related U.S. Application Data
(60) Provisional application No. 61/383,996, filed on Sep. 17, 2010.

(51) Int. Cl. E02D 11/00; G06G 7/48; E02D 5/54

(52) U.S. Cl. 405/232; 405/255; 703/7

(57) ABSTRACT

A base for holding a wind turbine tower is disclosed. The base includes individual shaft piles, a base cap and anchoring units. The base cap includes reinforcement inserts and is connected to each of the individual shaft piles. The anchoring units are embedded in the base cap and extend in an anchoring direction from the base cap at anchoring locations for anchoring the wind turbine tower to the base cap. Each of the reinforcement inserts extend in a radial direction relative to a center axis of the wind turbine tower. At least one of the plurality of reinforcement inserts, at a radius of the center axis adjacent to an anchoring location of a respective anchoring unit, has a portion of the respective reinforcement insert extending along the anchoring direction.

### CROSS-REFERENCE TO RELATED APPLICATIONS

This Application claims priority from U.S. Provisional Application No. 61/383,996, filed on Sep. 17, 2010. The contents of U.S. Provisional Application No. 61/383,996 are incorporated in their entirety by reference herein.

### BACKGROUND OF THE INVENTION

1. Field of the Invention

Exemplary embodiments of the present invention relate to foundations for a wind turbine generator and methods of design and construction thereof and, more particularly, to reinforced foundations used to support wind turbine towers and their design and construction.

2. Related Art

The installation of wind farms in the United States and abroad has become increasingly popular and the popularity of these environmentally favorable systems is expected to continue. Conventional foundations for small and mid-size wind turbines include gravity-based spread foundations with octagonal bases and cylindrical central pedestals.

### SUMMARY OF THE INVENTION

The present invention is embodied as a base for holding a wind turbine tower. The base includes a plurality of individual shaft piles and a base cap connected to each of the individual shaft piles. The base cap has a plurality of reinforcement inserts for reinforcement. The base further includes a plurality of anchoring units embedded in the base cap and extending in an anchoring direction from the base cap at anchoring locations to anchor the wind turbine tower to the base cap. Each of the reinforcement inserts extend in a radial direction relative to a center axis of the wind turbine tower. At least one of the plurality of reinforcement inserts, at a radius of the center axis adjacent to an anchoring location of a respective anchoring unit, has a portion of the respective reinforcement insert extending along the anchoring direction.

The present invention is embodied as a computer-implemented method of modeling behaviors of the base for the wind turbine tower and a non-transitory computer readable medium to store instructions to implement such a method. The method includes calculating, by a computer, post-tension force on each anchoring unit using load relaxation, material creep, and load distribution between or among at least the plurality of individual shaft piles, the base cap and the plurality of anchoring units, as components of the base, analyzing, by the computer, stress levels in the components of the base including reinforcement inserts and adjusting a size or a number of the plurality of individual shaft piles to support the wind turbine tower in accordance with the post-tension force and stress levels associated with the components of the base.

The present invention is embodied as a method of constructing the base for the wind turbine tower. The method includes drilling from a base level to establish a plurality of boreholes, installing base piles for each of the plurality of boreholes and establishing an open trench in the base level between two of the base piles. The method further includes filling at least the open trench with a mud slab, positioning a base cap on the mud slab, and connecting the base cap to each of the base piles to support the wind turbine tower.

### BRIEF DESCRIPTION OF THE DRAWINGS

The invention is best understood from the following detailed description when read in conjunction with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1 is a structural rendering of a wind turbine tower and foundation in accordance with an exemplary embodiment of the invention;

FIG. 2 is a view of region A of FIG. 1 illustrating an exemplary tower surmounted on a base cap, which is supported by shaft piles;

FIG. 3 is a plan view illustrating an exemplary anchoring plate, a plurality of anchoring holes, a base cap, and shaft piles in accordance with an exemplary embodiment of the invention;

FIG. 4 is a schematic drawing illustrating an exemplary anchoring bolt and shear bar system in accordance with an exemplary embodiment of the invention;

FIG. 5 is a cross sectional view of an exemplary anchoring bolt and shear bar system with reinforcements in accordance with an exemplary embodiment of the invention;

FIG. 6A is an analysis to verify that an exemplary base cap reinforcement is sufficient, is illustrated using a three-dimensional, finite element model in accordance with an exemplary embodiment of the invention;

FIG. 6B is a system for execution and display of the three-dimensional, finite element model of FIG. 6A;

FIG. 7 is a graphic illustrating exemplary tensile stresses developed in the anchoring reinforcement structure of FIG. 5;

FIG. 8A is a view illustrating a reinforcement structure for the plurality of shaft piles.

FIG. 8B is a cross sectional view taken along a line A-A of FIG. 8A.

FIGS. 8C and 8D are partial cross sectional views of an exemplary arrangement of longitudinal bars with out-hooks at a top of the shaft piles that are disposed in the base cap. FIG. 8C is a view taken along a line B-B and FIG. 8D is a view taken along a line C-C.

FIG. 9 is a partial perspective view illustrating an exemplary reinforcement structure for the base cap in accordance with an exemplary embodiment of the invention;

FIG. 10A is a plan view illustrating the exemplary reinforcement structure in the base cap of FIG. 9;

FIGS. 10B and 10C are views of the base cap of FIG. 9 illustrating outer and inner bent bars and straight surface bars, respectively;

FIG. 11 is a plan view of an exemplary ditch disposed below the base cap and a cable conduit in accordance with an exemplary embodiment of the invention;

FIG. 12 is a partial cross sectional view taken along a line D-D of FIG. 11 illustrating the cable conduit;

FIG. 13 is a flow chart illustrating a method of construction of a base for a wind turbine tower in accordance with an exemplary embodiment of the invention; and

FIG. 14 is a flow chart illustrating a method of modeling behaviors of a base for a wind turbine tower in accordance with an exemplary embodiment of the invention.

### DETAILED DESCRIPTION OF THE PREFERRED EMBODIMENTS

Spread foundations may include a substantial self weight from a concrete base, which may extended, for example, 30 to 100 feet or more in diameter or width. If the soil in a shallow layer is not strong, such a spread foundation may have to be seated at a deeper layer, which may increase the cost significantly.

What is needed is a foundation for a wind turbine tower which may be optimized for site conditions (including, for example, reduced weight) and may allow ease of installation at a reduced cost.

The interaction between the foundation members and the soil around the foundation may be considered in view of the relatively large values of ground-line shear and overturning moment.

Certain exemplary embodiments may relate to a highly reliable foundation system for support of large and tall wind-turbine towers in a wide range of soil and rock formations.

Certain exemplary embodiments may include: (1) a foundation system that may use high-capacity drilled shaft piles to support large turbines in any kind of subsurface conditions; (2) a reinforcement structure for integrating the drilled shaft piles and the base cap together so that the base cap may distribute the loads to each drilled shaft piles without connection failure; and/or (3) a shear-bar arrangement for integrating the base cap and the embedded mounting plate of the wind turbine tower together so that risk of pullout failure of the embedded mounting plate may be substantially reduced or eliminated. Drilled shaft piles generally refers to reinforced structures such as caissons, drilled shafts, piers, and/or bored piles, among others).

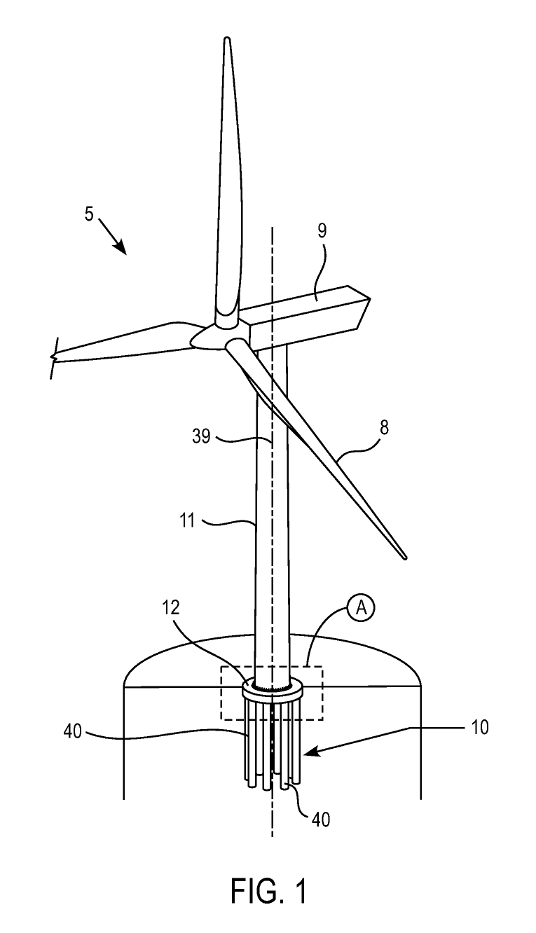

FIG. 1 is a structural rendering of a drilled-shaft foundation used to support a wind-turbine tower in accordance with an exemplary embodiment of the invention.

Referring to FIG. 1, the wind turbine 5 may include a plurality of wind turbine blades 8, a turbine 9, a foundation 10, and a wind turbine tower 11 having a center axis 39. Each of the plurality of wind turbine blades 8 may be in a range of about 25 meters to about 125 meters in length, for example. The wind turbine tower 11 may be in a range of about 50 meters to about 150 meters in length or more. The base diameter of the wind turbine 5 may be in the range of about 2 to 10 meters. The maximum turbine-induced loads at the base (e.g., of the foundation) may be the coupled bending moment and shear force. The turbine 9 may be coupled to the plurality of wind turbine blades 8 to rotate together with the plurality of wind turbine blades 8 in response to wind moving across the wind turbine blades 8. The turbine 9 may generate 1 to 10 MW of power, as an exemplary range, and may couple to an electric grid (not shown) to supply the generated power to utilities or other customers. The foundation 10 may include a base cap (or pile cap) 12 and a plurality of individual shaft piles 40. Rocking vibration or overturning moments may dominate the behavior of the foundation and the performance of the wind turbine 9.

The plurality of individual shaft piles 40 may be drilled shaft piles. The base cap 12 may be a circular base cap, but is not limited to one particular geometric shape. The base cap 12 may include, for example, Portland cement concrete or other concrete mixtures and predetermined reinforcements. The reinforcements may be inserts or shear bars and may be made of steel or other metal compositions. The thickness of the base cap 12 may vary in a range from 2 to 10 ft. or more and may be optimized to be in the range of 3 to 5 ft for convenience in construction in this exemplary embodiment, but its dimensions depend on design load parameters. The top of the base cap 12 may be in a range of about 6 inches to 18 inches above a finish grade (e.g., 1 ft.), but this dimension is not critical. By the design of at least one exemplary embodiment, the amount of excavation for the foundation 10 and its thickness will be minimized compared with other types of conventional wind turbine foundation systems for similarly sized wind turbines, and may comparatively reduce environmental impact, though these advantages are not required to be part of the invention (e.g., a foundation can be over-built but still be in accordance with the present description).

The base cap 12 may be supported by shaft piles 40 (e.g., drilled shaft piles), which may be extended to a desired depth based on a design (e.g., a design requirement) for a maximum expected load, for example, due to overturning, torsion, and horizontal shear and/or gravity loads from the turbine 9 and associated components.

The drilled shaft piles 40 (e.g., reinforced concrete) may be circular in cross section and may be fabricated in place to depths to sustain the design loads of the foundation 10. The drilled shaft piles 40 may be reinforced with steel bars and may be arranged in a circular pattern and/or any pattern symmetrical with the center axis 39 of the wind turbine tower 11. The drilled shaft piles may extend to a sufficient depth to resist the specified maximum extreme loads, without causing a stability problem or yielding in the structural members.

For example, the plurality of drilled shaft piles 40 design may be favorable relative to a single pier foundation because axial resistance (compression and/or tension depending on the shaft locations) along the drilled shaft piles 40 may support the gravity load and/or the large overturning moment, and the shear may be distributed to the drilled shaft piles 40. The use of drilled shaft piles 40 may increase the natural frequency of the wind turbine 5 and may decrease the amplitude of vibration relative to the single pier foundation system.

Certain exemplary embodiments may use high-capacity (e.g., having a strength above a threshold) drilled shaft piles 40, which may be arranged in a pattern (e.g., a circular or other pattern) and may be connected (e.g., rigidly connected) with a reinforced base cap (e.g., concrete cap), to provide sufficient capacity against the overturning bending moment on the base or foundation.

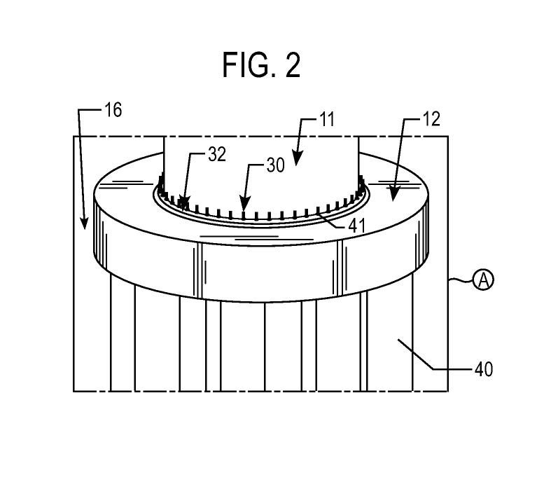

FIG. 2 is a view of region A of FIG. 1 illustrating an exemplary wind turbine tower 11 surmounted on a base cap 12 (e.g., a concrete cap), which is supported by the shaft piles 40 (e.g., drilled shaft piles).

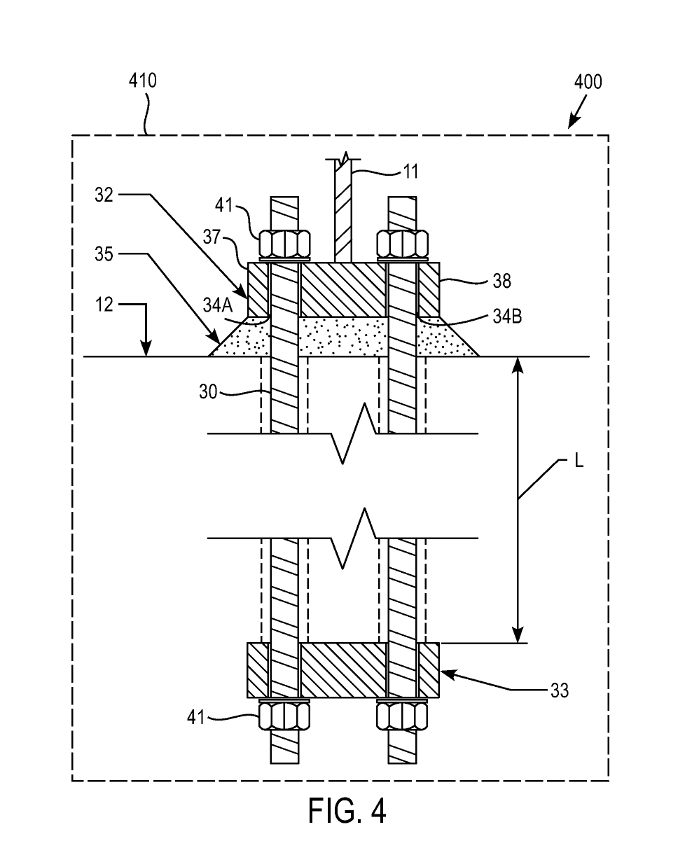

Referring to FIG. 2, the wind turbine tower 11 may be a tubular steel tower and may be seated (e.g., surmounted) on a top of the base cap 12 by fastening anchoring bolts 30 between the mounting plate 32 of the wind turbine tower 11 and an embedded mounting plate 33 (see FIG. 4). The foundation 10 may maintain an embedment 16 in the range of about 3 ft. to 9 ft. or more and may depend on the overall height of the foundation 10 and the diameter (e.g., the width and length) of the foundation 10. The mounting plate (or anchoring plate) 32 may be integral to a bottom of the wind turbine tower 11 and may have a circular shape to connect the wind turbine tower 11 to the base cap 12 via a plurality of spaced apart anchoring bolts 30. Hex nuts (or other shaped nuts) 41 may be used as a fastener to firmly and rigidly connect the wind turbine tower 11 to the base cap 12 via the plurality of anchoring bolts 30.

In certain exemplary embodiments, a circular reinforced-concrete cap may have an embedment depth (e.g., of less than 4 ft depending on other design parameters) to reduce the environmental impact from construction.

In certain exemplary embodiments, the mounting plate 32 may be separate from the wind turbine tower 11 and have a diameter that corresponds to and mates with a lower portion of the wind turbine tower 11 and a top of the base cap 12.

In various exemplary embodiments, the wind turbine tower 11 may include two or more sections. The mounting plate 32 may be integral with a lowest section of the wind tower turbine 11 such that one or more upper sections of the wind turbine tower 11 mounts on top of lower section to construct the wind turbine tower 11.

In certain exemplary embodiments, it is contemplated that the wind tower turbine 11 may include two sections (e.g., an upper section and a lower section) such that the lower section has a height less than the height of the upper section to enable ease of mount of the upper section (e.g., which is larger than the lower section) directly to the lower section.

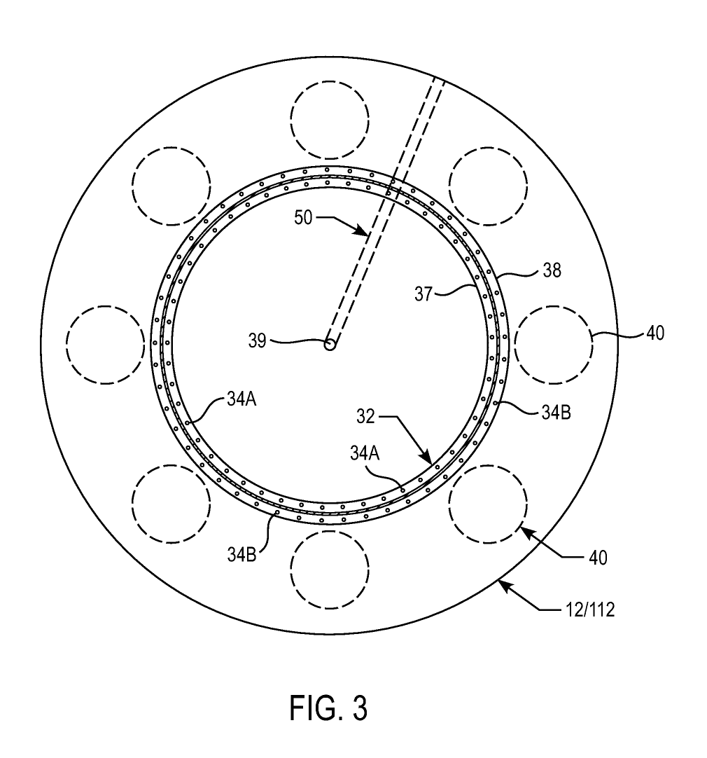

FIG. 3 is a plan view illustrating an exemplary tower-base mounting plate 32, a plurality of anchoring holes 34A and 34B, the base cap 12, and the shaft piles 40 in accordance with an exemplary embodiment.

Referring to FIG. 3, an exemplary tower-base mounting plate 32 may be circularly shaped and may include the plurality of anchoring holes 34A and 34B for receiving a plurality of corresponding anchoring bolts 30. The mounting plate 32 may include inner and outer flanges 37 and 38 projecting from the tubular wind turbine tower 11. The inner flange 37 may include a first set of anchoring holes 34A and the outer flange 38 may include a second set of anchoring holes 34B. The number of anchoring holes 34A in the first set and the number of anchoring holes 34B in the second set may be equal and may be spaced apart at equal angular positions relative to the center axis 39 of the tubular wind turbine tower 11.

The base cap 12 may be a circular shape or, for example, another shape including a polygon shape with any number of sides. The shaft piles 40 may be a circular shape and may extend downward (e.g., by drilling) into soil or rock formations to support the base cap 12. The base cap 12 may be connected to and may be supported by the plurality of drilled shaft piles 40 via a reinforcement structure.

FIG. 4 is a schematic drawing illustrating an exemplary anchoring bolt and shear bar system 400 in accordance with an exemplary embodiment of the invention.

Referring to FIG. 4, the exemplary anchoring bolt and shear bar system 400 may include anchoring bolts 30, hex nuts 41, a mounting plate 32, and an embedded mounting plate 33. A pair of anchoring bolts 30, corresponding hex nuts 41, the mounting plate 32, and the embedded mounting plate 33 may form an anchoring unit 410.

The anchoring bolt and shear bar system 400 may include a plurality of anchoring units 410 spaced apart at a predetermined radius from the center axis 39. Each anchoring unit 410 may use: (1) a single mounting plate 32 and (2) a single embedded mounting plate 33 common to the anchoring units 410 (e.g., common to all anchoring units 410).

The wind turbine tower 11 may be circular and/or tubular in shape. The mounting plate 32 may be integral with the wind turbine tower 11 and may rigidly fasten via fasteners, e.g., the hex nuts 41 and the anchoring bolts 30 (or other fasteners) to a circular embedded mounting plate 33. The embedded mounting plate 33 may be embedded to a length L (e.g., a threshold length of at least about 2 feet to 3 feet in this example) inside the base cap 12. The embedded mounting plate 33 may be vulnerable to a pullout failure where the thickness of the base cap 12 is reduced. A high strength grout layer 35 may be disposed between the mounting plate 32 and the base cap 12.

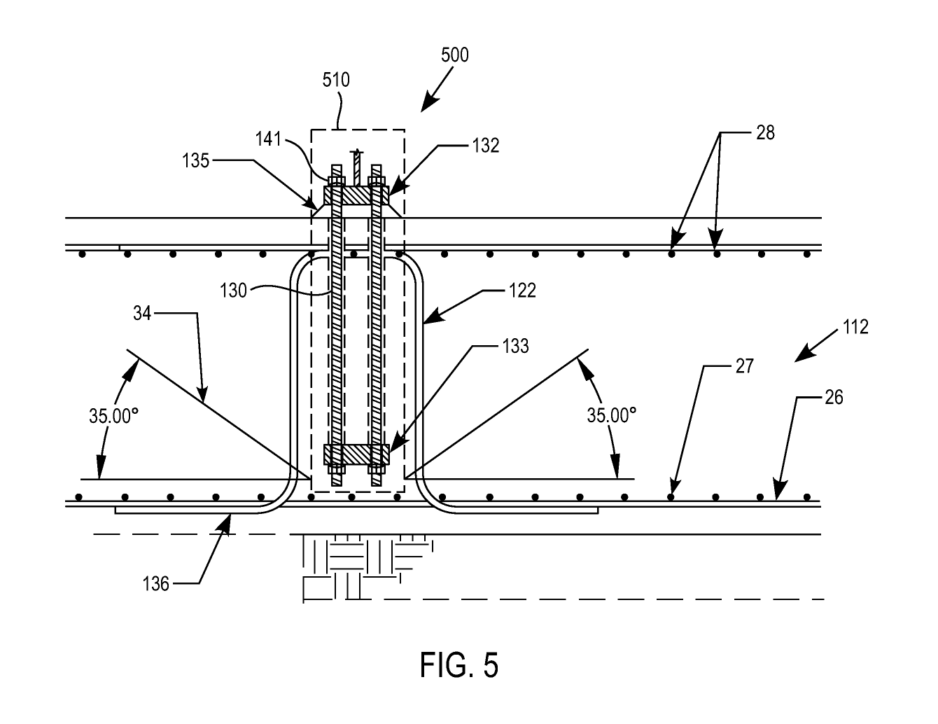

FIG. 5 is a cross sectional view illustrating an exemplary anchoring bolt and shear bar system 500 including a reinforcement structure in accordance with an exemplary embodiment of the invention.

Referring to FIG. 5, the exemplary anchoring bolt and shear bar system 500 may include anchoring bolts 130, hex nuts 141, a mounting plate 132, and an embedded mounting plate 133. A pair of anchoring bolts 130, corresponding hex nuts 141, the mounting plate 132, and the embedded mounting plate 133 may form an anchoring unit 510.

A plurality of anchoring units 510 may be spaced apart at a predetermined radius from the center axis 39. Each anchoring unit 510 may use: (1) a single mounting plate 132 and (2) a single embedded mounting plate 133 common to the anchoring units 510. The mounting plate 132 may be integral with the wind turbine tower 11 and may rigidly fasten via fasteners (e.g., hex nuts (or other shaped nuts) 141 and anchoring bolts 130) to an embedded mounting plate 133. The embedded mounting plate 133 may be embedded in the base cap 112 (e.g., a concrete cap) at a threshold length L (e.g., of about 2 feet to about 3 feet in this example) and the thickness of the base cap 112 may be about 3 feet to 5 feet in this example. The base cap 112 may include a reinforcement structure that may include shear anchoring bars 122, outer bent bars 26, inner bent bars 27 and straight surface bars 28.

For example, shear resistance from concrete material along a potential failure cone (e.g., represented by line 34 originating from the embedded mounting plate 133 and rotated about the embedded mounting plate 133) may be sufficient for the base cap 112 of FIG. 5 within a range of 3 feet to 5 feet of thickness for example for the base cap 112 with the reinforcement structure. Shear resistance from concrete material along a potential failure cone from the same region in FIG. 4 may not be sufficient for the base cap 12 of FIG. 4 within the same range (e.g., 3 feet to 5 feet of thickness for the base cap 12) without any reinforcement structure.

To avoid pullout failure, the shear bars 122 and/or other reinforcements (e.g., outer bent bars 26, inner bent bars 27 and/or straight surface bars 28, among others) may be added to the base cap 12 of FIG. 4 to reduce or eliminate pullout failure. For example, the shear bars 122 may be placed across the pullout failure cone associated with each anchoring unit 510. The shear bars 122 may prevent a concrete breakout failure due to a decrease in the thickness of the base cap 112. For example, larger uplift forces from the wind turbine tower 11 may be safely transferred to the shaft piles 40 from the base cap 112 without a risk of pullout failure associated with the structure of the base cap 12.

The shear bars 122 with a bent shape (e.g., an extended U-shape) may be placed with equal spacing (e.g., equal circumferential spacing or equal angular spacing) to cross a circumference defined by the embedded mounting plate 133. The shear bars 122 may have end sections 136 extending orthogonal to or substantially orthogonal to the anchoring direction of the anchoring units 510 and the end sections 136 may have a length to substantially reduce or eliminate pullout failure. The length may be determined based on rules, for example, as specified in rules or codes from the American Concrete Institute (ACI) or governmental agencies such as the US Department of Transportation or industry standards.

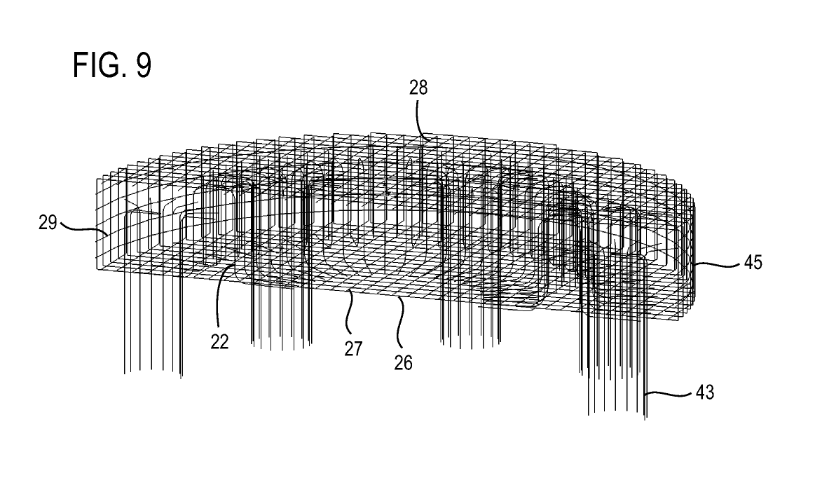

The outer and inner bent bars 26 and 27 of the base cap 112 and the straight surface bars 28 may be formed into a cylindrical cage 45 (see FIG. 9). Each end section of the shear bars 122 may be placed below or weaved into the outer bent bars 26 and the inner bent bars 27 of the base cap 112, at a lower section of a cylindrical cage 45.

A range of about 1 to 12 inches (e.g., approximately 4 inches) of high strength grout 135 (e.g., that is above a threshold strength) may be placed between the mounting plate 132 and the top of the base cap 112 as a cushion because the mounting plate 132 and the base cap 112 exhibit differences in engineering properties. Anchoring bolts 130 may be pre-stressed to maintain the concrete around the mounting plate 132 to be in compression so tension fatigue and separation may be prevented between the mounting plate 132 and the grout 135. The post-tension force to be applied on each anchoring bolt 130 during installation may be predetermined by calculation using a 3-dimensional Finite Element Stress (FES) analysis of the base cap 112 simulated for expected loading from the wind turbine tower 11 under maximum operating conditions.

In certain exemplary embodiments, a plurality of (e.g., two or three) shear bars 122 may be bundled together with correspondingly wider spacing (e.g., double or triple the specified spacing) to reduce the construction time and construction costs. The function and contribution of the shear bars 122 may be validated by using advanced numerical analyses (e.g., 3-dimensional FES analysis).

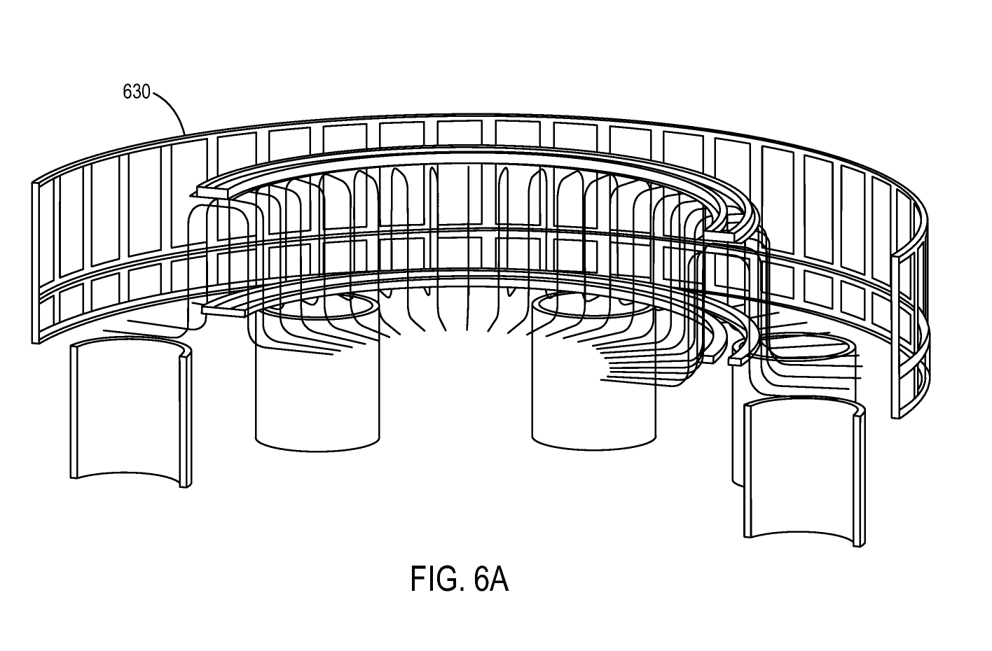

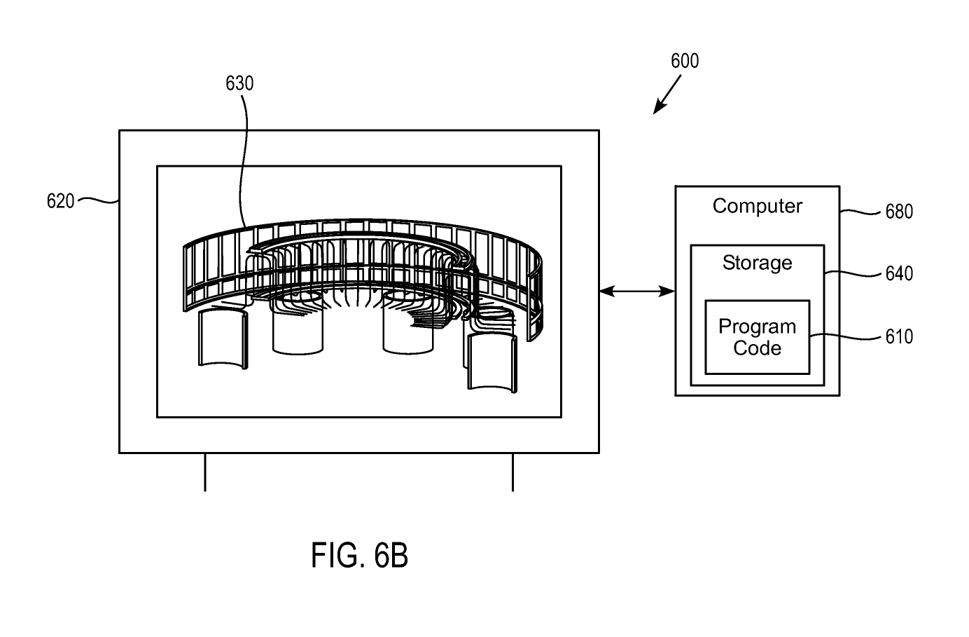

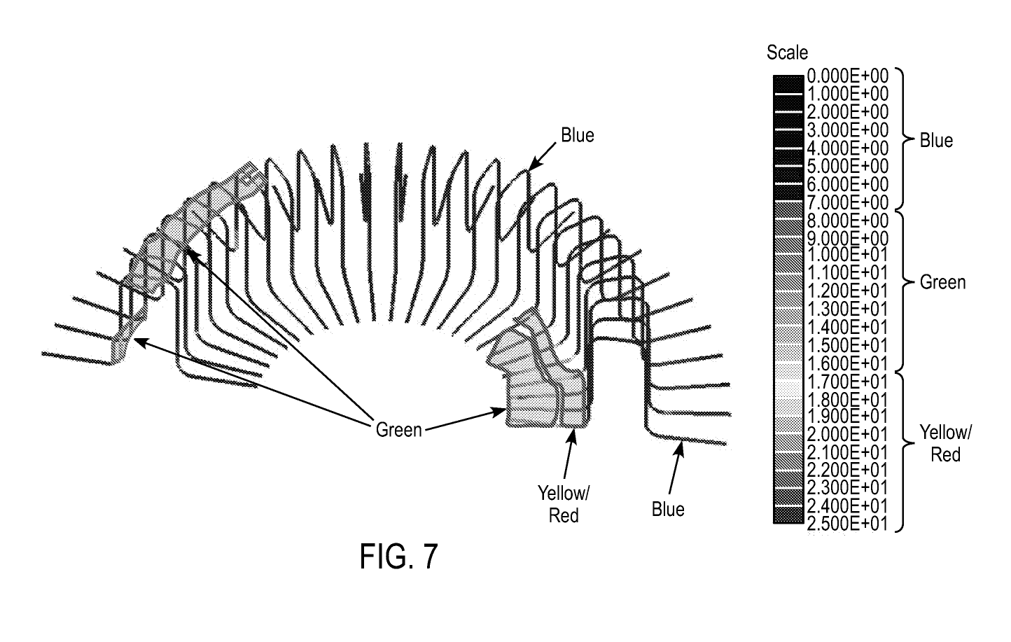

FIG. 6A is an analysis to verify that the exemplary base cap reinforcement is sufficient, illustrated using a 3-dimensional FES analysis of one-half of the foundation 10, with symmetry imposed for the foundation 10. FIG. 6A shows an outline of the base cap 112 (e.g., concrete cap) and shear bar reinforcement. FIG. 6B is a system 600 for displaying the 3-dimensional FES analysis of FIG. 6A. FIG. 7 is a graphic illustrating exemplary tensile stresses developed in the anchoring reinforcement (shear bars) 122 during loading (e.g., maximum expected loading). The tensile stress levels are illustrated as different colors (e.g., blue in the range of about 0 to 7 (on the scale), green in the range of about 8 to 16 (on the scale), yellow in the range of about 16 to 19 (on the scale) and red in the range of about 19 to 25 (on the scale). Regions of the shear bar reinforcement 122 having different stress levels are indicated with blue, green, yellow and red colors that are associate with the colored scale.

Referring to FIGS. 6A, 6B and 7, the system 600 may include a computer 680 and a display 620. The computer 680 may execute a program code 610 (stored in memory 640) for the display by display 620 of FES analysis 630 illustrated in FIG. 6A. Several physical quantities related to structural performance may be evaluated in the analysis. One such quantity may be the principal tensile stress in the anchoring reinforcement as shown in FIG. 7. The largest tensile stress developed in an exemplary anchoring reinforcement 122 may be about 271 MPa (not shown on scale), which is approximately equal to 40 ksi. The exemplary anchoring reinforcements 122 may have yield strength of 60 ksi, which shows that the anchoring reinforcements 122 perform adequately.

One of skill in the art understands how to develop the stress analysis, as shown in FIG. 6A, from the commercially-available 3-Dimensional FEM (Finite-Element Method) codes incorporated in the design procedures to meet building codes for reinforced-concrete structures. In order to verify that the concrete strength and the reinforcement in the pile cap is sufficient, a three-dimensional, finite element model of the pile cap may be developed. The FEM model may be created by using, for example, a commercially-available computer program (ATENA available from Cervenka Consulting). Different types of finite elements and material constitutive models may be used to represent the structural components (e.g., concrete, steel anchor plate, and/or reinforcing steel bars, among others) and their material properties. In order to simulate the physical behavior between, for example, the concrete and reinforcing steel bars, the bonding mechanism material model used to define the interface between the concrete and the steel bars may considered. The FEM models are used to generate the 3-Dimensional FES analysis (e.g., to evaluate the stress levels) under different loading conditions, including for evaluation of the stress levels under extreme loading (e.g., loading in excess of a threshold level). One of skill in the art understands how to evaluate the FEM results.

By performing the FES analysis for the anchoring reinforcements and other reinforcements (e.g., the rebar), stresses in the foundation 10 may be limited to reduce the likelihood of long-term fatigue failure under the expected range of loadings on the wind turbine tower 11. The FES analysis may model the behavior of the foundation under different loading conditions. Loads may be applied to the foundation 10 by the base of the wind turbine tower 11 through the pre-tensioned anchor bolts 130 connecting the base of the wind turbine tower 11 to the pile cap 12.

The wind turbine tower loads may be transferred from the anchor bolts 130 to the tops of the drilled shaft foundation members by the development of shear forces and bending moments in the pile cap 12. The shear forces and bending moments may develop in the pile cap 12 by the development of compressive forces in the concrete and the development of both tensile and compressive forces in the reinforcing steel embedded in the concrete. In the zones of the pile cap 12 where large shear forces may develop in the concrete, shear reinforcement may be provided by steel reinforcement that crosses the zones where the shear stresses develop. The pile cap 12 may be supported by the development of shear forces and bending moments at the tops of the drilled shaft foundations. The shear forces and bending moments at the tops of the drilled shaft foundations may be transferred to the supporting soil and rock by the structural stiffness and structural capacity in axial compression, axial uplift, bending moment, and shear performance of the drilled shaft foundation.

The dimensions of the drilled shaft piles may be determined from the magnitudes of loading to be supported and from the axial and lateral load transfer characteristics of the supporting soil and rock. An evaluation of the results of the three-dimensional FES analysis may be included in the design process to ensure that the stresses developed in the concrete and steel reinforcement are within acceptable limits for material creep under sustained structural loading and prevention of long-term fatigue failure under cyclic loadings.

The magnitude of post-tension forces on the anchor bolts may be calculated based on principles of engineering mechanics. The post-tension forces may be sized to minimize or eliminate physical separation between the anchor plate and the reinforced concrete cap. Load relaxation, material creep, and/or load distribution may be considered so that the post-tension forces on each anchor bolt may be sufficient to keep the concrete elements in compression during normal operation to reduce the occurance of fatigue-related failures, as may be dictated by long-term performance for the structure.

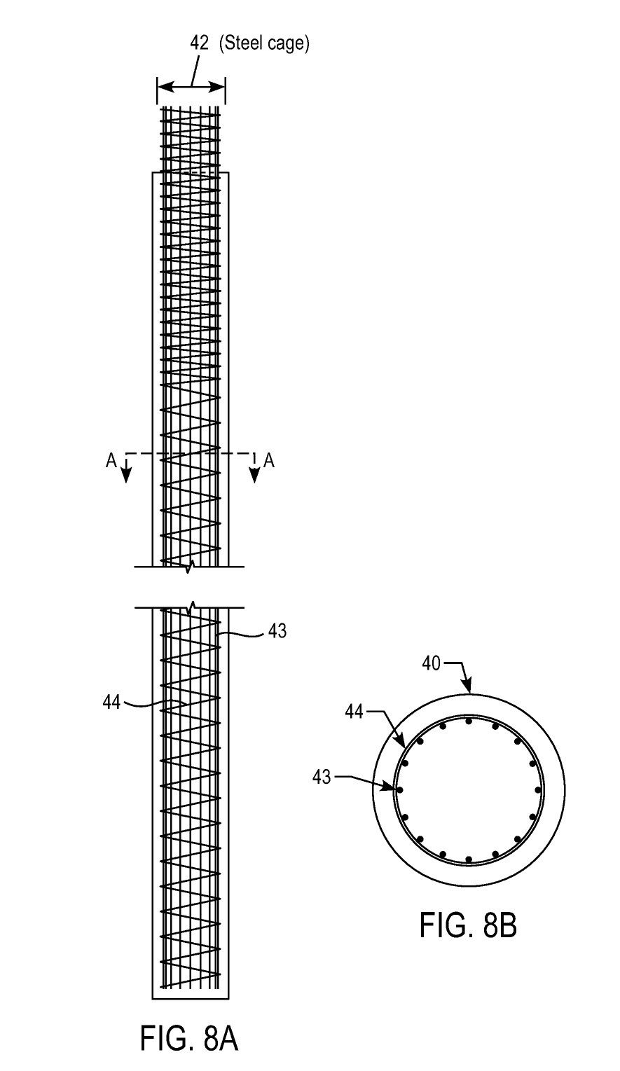

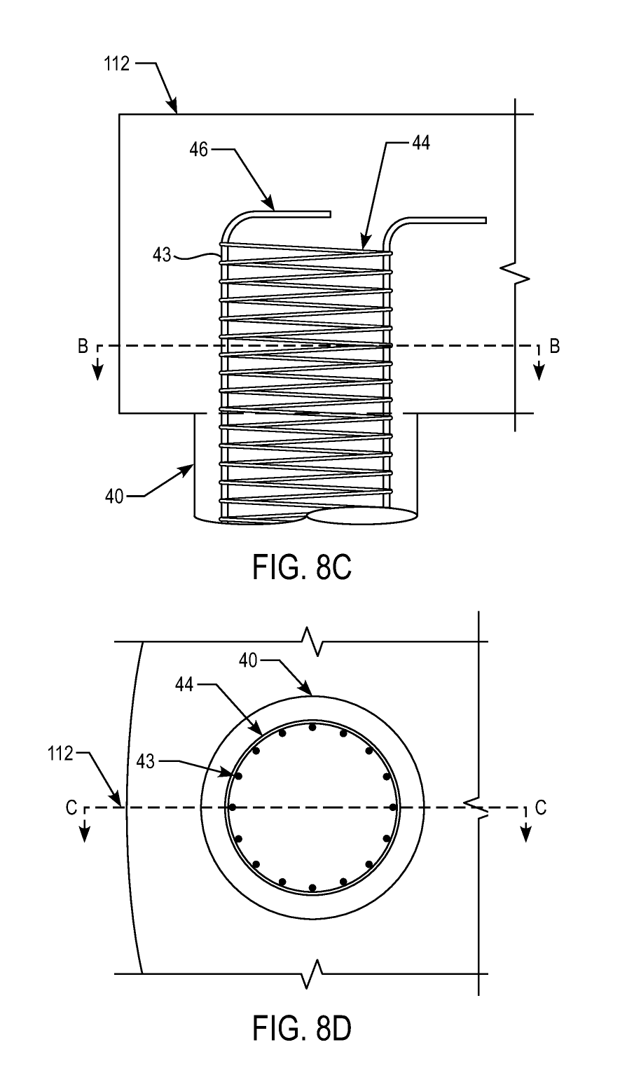

FIG. 8A is a view of an exemplary reinforcement structure for the plurality of shaft piles 40. FIG. 8B is a cross sectional view taken along a line A-A of FIG. 8A. FIGS. 8C and 8D are partial cross sectional views of an exemplary arrangement of out-hooks 46 for the longitudinal bars 43 at a top of the shaft piles 40 that are disposed in the base cap 112. FIG. 8C is a view taken along a line C-C and FIG. 8D is a view taken along a line B-B.

Referring to FIGS. 8A-8D, each shaft pile 40 may include a reinforcement cage 42 (e.g., for reinforcement of properly casted concrete) that may have a plurality of longitudinal reinforcement bars 43 and/or one or more transverse reinforcements 44 (e.g., steel bars). The transverse reinforcements 44 may include either spiral steel ties or tied steel hoops (not shown). For example, spiral steel ties may be used for reinforcement of drilled shaft piles 40 with diameters of about 36 inches or less and tied steel hoops (not shown) may be used for the drilled shaft piles 40 larger than about 36 inches in diameter. The pitch of spiral steel ties 44 may increase towards a bottom of the drilled shaft pile 40. Properly casted concrete generally refers to pouring concrete and providing vibration or other mixing to the poured concrete to ensure that the concrete displaces voids (e.g., all voids) around formwork and reinforcements.

In certain exemplary embodiments, the load distribution between the embedded anchoring plates and the drilled shaft piles may be secured by an arrangement and integration of shear bars, longitudinal bars, and/or transverse bars together.

Each of the plurality of longitudinal reinforcement bars 43 of the reinforcement cage 42 may include a bent hook portion (out-hook) 46 that may be disposed or embedded in the base cap 112 and may extend in a radial direction towards the center axis 39 of the wind turbine tower 11.

In certain exemplary embodiments, a secured connection between the drilled shaft piles 40 and the base cap 112 may be implemented by arranging the out hooks 46 of the longitudinal reinforcement bars 43 from the drilled shaft piles 40 to weave together with the surface bars 28 previously positioned in the base cap 112.

In certain exemplary embodiments, the size of the longitudinal bars 43 may be equal to a #8 size or less based on ASTM A615 standard bar sizes and may be bent by personnel at the construction site. Steel bars (or other metal or composite bars) greater than bar size #8 may have difficulty being bent at the construction site using tools commonly brought to the construction site. Bar terminators may be used for those situations.

Although the out-hooks are shown to be a common length, it is contemplated that respective out-hooks may be of different lengths based on wind and other loading expected on the base cap 112.

Although each of the out-hooks is shown extending in a radial direction towards the center axis 39 of the wind turbine tower 11, it is contemplated that the out-hooks may extend in a different common direction (e.g., different than the radial direction) or that each of the out-hooks may extend in different directions.

It is contemplated that other methods of construction and design of the drilled shaft piles may follow the recommendations by US Department of Transportation, Federal Highway Administration (for example, in Report Nos. FHWA-IF-99-025 and FHWA-NHI-10-016).

To ensure the base cap (e.g., entire base cap) is reinforced properly, selected sizes of steel bars may be weaved throughout the heavily-stressed sections, which may be identified by an advanced numerical analytical program (e.g., procedure) executed on a computer and the results may be displayed on a display on a display for a user.

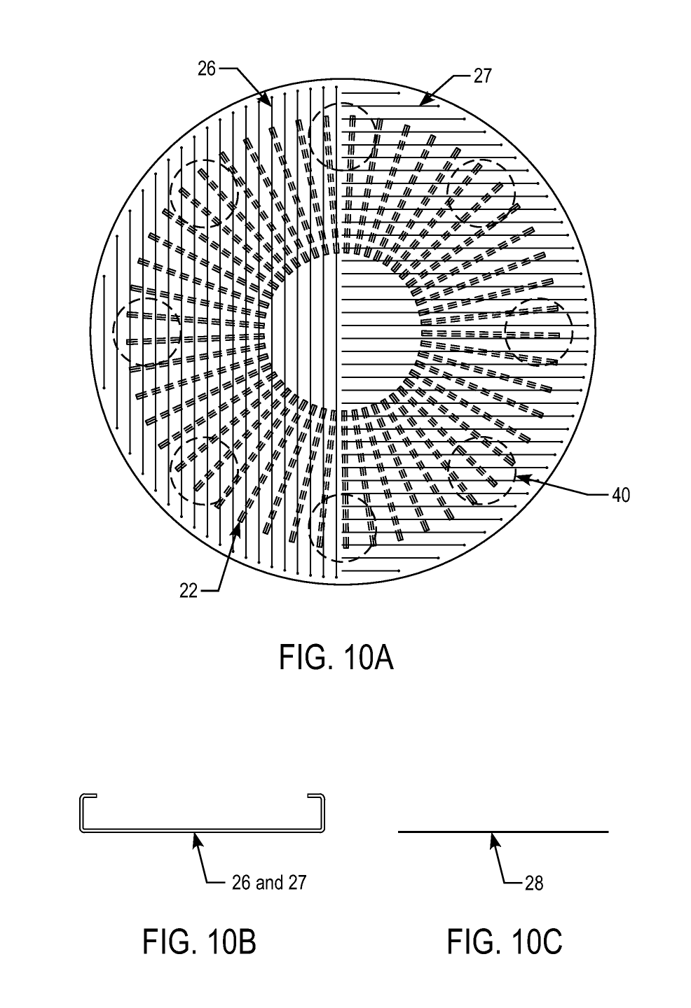

FIG. 9 is a partial perspective view illustrating an exemplary reinforcement structure for the base cap 112 in accordance with an exemplary embodiment of the invention. FIG. 9 shows half of the exemplary reinforcement structure of the base cap 112. The other half of the exemplary reinforcement structure of the base cap 112 may be substantially identitical or identical to the reinforcement structure shown. FIG. 9 does not show any anchoring bolts, embedded mounting plate or mounting plate for simplification of FIG. 9. FIG. 9 illustrates the relative locations and densities of reinforcement structures (e.g., surface and embedded rebar or steel). FIG. 10A is a plan view illustrating the exemplary reinforcement structure in the base cap 112 in FIG. 9 and FIGS. 10B and 10C are views of the base cap 112 of FIG. 9 illustrating outer and inner bent bars and straight surface bars, respectively.

Referring to FIGS. 9, 10A, 10B and 10C, the cylindrical cage 45 may be formed from: (1) the outer bent bars 26 that may extend in a first direction at the lower section of the cylindrical cage 45 and may be bent at each end to form a cylindrical shaped base cap 112; and/or (2) the inner bent bars 27 that may extend in a second direction that may be substantially orthogonal to the first direction at the lower section of the cylindrical cage 45 and may be bent at each end to form a cylindrical shaped base cap 112. The inner bent bars 27 may be disposed within the outer bent bars 26 to form the cylindrical cage 45 having steel bars extending in two different directions for increased reinforcement. The outer bent bars 26 and the inner bent bars 27 may be, for example, #8 size bars and may be bent and tied together at the construction site with standard tools to form the lower section of the cylindrical cage 45. The straight surface bars 28 may be formed into an upper matrix or grid structure by extending the straight surface bars 28 in the two different directions and may be tied to an upper portion of the outer bent bars 26 and the inner bent bars 27. The cylindrical cage 45 may include inner bent circumferential reinforcements 29 extending around a periphery of the cylindrical cage 45. The inner bent circumferential reinforcements 29 may be disposed in the outer bent bars 26 and the inner bent bars 27 and may be tied to the outer bent bars 26 and the inner bent bars 27 at respective crossing points.

Although FIG. 10A shows the outer bent bars 26 extending across the cylindrical cage 45 for half of the cylindrical cage 45 and the inner bent bars 27 extending across the other half of the cylindrical cage 45 for simplicity, one of skill understands, as shown in FIG. 9, that the outer bent bars 26 and the inner bent bars 27 may form a grid or matrix pattern across the lower section of the cylindrical cage 45.

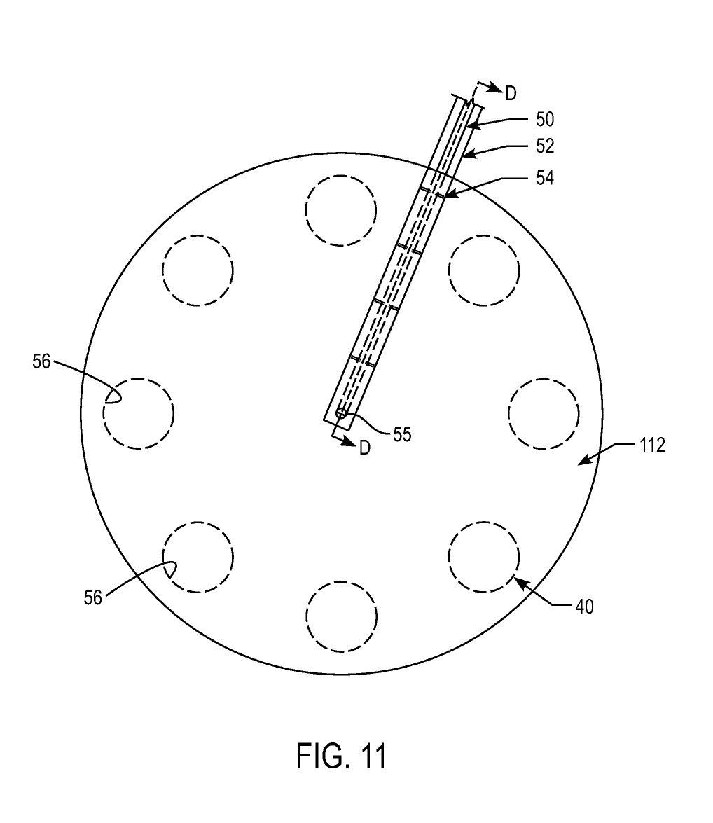

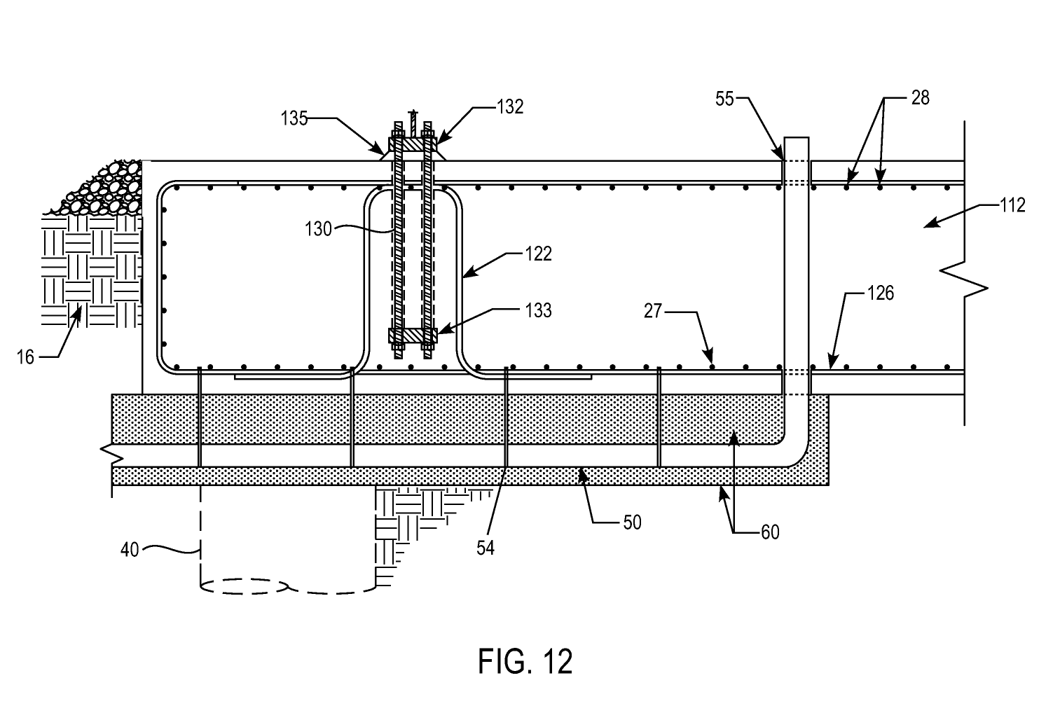

FIG. 11 is a plan view of an exemplary ditch disposed below the base cap 112 and the cable conduit 50 in the ditch. The exemplary ditch may be back-filled around the cable conduit 50 prior to construction of the base cap 112. FIG. 12 is a partial cross sectional view taken along a line D-D illustrating the cable conduit 50 inside a back-filled trench 52, which may be fastened by hangers 54 to the base cap 112 for support in case of erosion (e.g., scour-induced erosion) of soil from around the base cap 112.

Referring to FIGS. 11 and 12, a ditch may be excavated below ground level (e.g., below grade) for construction of the foundation (base) 10 of the wind turbine tower 11. A plurality of boreholes 56 may be drilled into the floor of the excavated ditch and may be used to construct the drilled shaft piles 40. An open trench 52 may be excavated from a center axis 39 of the wind turbine tower 11 below the base cap 112 to beyond an outer perimeter of the base cap 112 such that cables (e.g. electric cables and/or other utility or control wires) may pass from beyond the outer perimeter of the base cap 112 (for example, from the electric grid or control center) to the turbine 9 via an open trench 52, a center opening 55 in the base cap 112 and a center opening (not shown) of the wind turbine tower 11.

In certain exemplary embodiments, the cable conduit 50 may be arranged in (e.g., placed inside) the open trench 52 below the base cap 112 and the open trench 52 may be filled with a grout layer or mud slab 60. The cables may be passed through (e.g., pulled through) an L-shaped cable conduit 50 extending through the center opening 55 of the base cap 112 to shield the cables under the base cap 112. The cable conduit 50 placed inside the trench 52 may be fastened by hangers 54 (e.g., steel hangers) to support the cable conduit 50, for example, in an event of settling of the soil adjacent to or under the cable conduit 50.

Although eight drilled shaft piles are illustrated in FIG. 11, it is contemplated that more or fewer drilled shaft piles are possible including a range of about 8 to 12 drilled shaft piles. The drilled shaft piles may be symmetrically located about the center axis of the wind turbine tower and connected to an outer portion of the base cap.

Although a single circular ring of drilled shaft piles is illustrated, it is contemplated that a plurality of circular rings may be included in the base cap such that a set of drilled shaft piles may be included in an inner ring for connection to the base cap at an inner portion and one or more other sets of drilled shaft piles may be included in a sequence of one or more successive outer rings. It is contemplated that the construction of the base cap for such a configuration of drilled shaft piles is similar to that described except that the attachment locations for the drilled shaft piles change.

Although the drilled shaft piles are illustrated as identical (e.g., in diameter, construction materials and length), it is contemplated that each drill shaft may be designed individually to meet load requirements, for example based on differences in soil composition at the construction site.

In certain embodiments, the some or all of the reinforcement inserts or reinforcement structures may by rods, bars or other shapes, for example, pipe shaped or polygonal shaped in cross section.

Although the foundation system is illustrated using concrete reinforced with steel rebar, it is contemplated that other materials are possible, for example, other high strength concrete mixtures that include filler such as organic and inorganic fibers and/or composites to: (1) increase the strength of the base cap in tension; (2) increase ductility; and/or (3) increase durable, among others. It is also contemplated that other reinforcement materials may be possible such as metal composites other than steel.

Certain exemplary embodiments may include an integrated drilled-shafts/mounting plate foundation for a large above ground wind-turbine tower subject to high overturning bending moment. Such exemplary embodiments may include one or more features of: (1) a circular reinforced-concrete cap at the ground lever with embedded mounting plates, to which the base of the tower of the wind turbine generator is surmounted; (2) a circular reinforced-concrete cap mounted atop multiple circular reinforced concrete drilled shaft piles, which are fabricated in place to depths as required to sustain the design loads of the foundation; (3) drilled shaft piles reinforced with steel bars and arranged in a circular pattern; the drilled shaft piles being installed vertically or with a battered angle to maximize the soil resistance and designed to withstand axial compression and tension loading in combination with lateral shear and bending load to sustain (e.g., required to sustain) the design loads of the foundation based on or in accordance with wind turbine generator loading and/or local building codes.

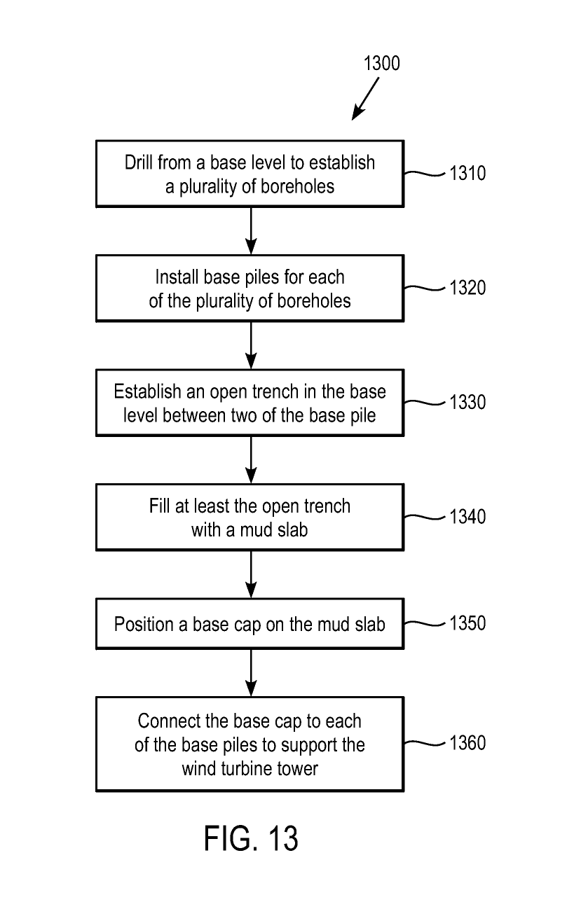

FIG. 13 is a flow chart illustrating a method 1300 of construction of a base 10 for a wind turbine tower 11 in accordance with an exemplary embodiment of the invention.

Referring to FIGS. 13, at the block 1310, a plurality of boreholes 56 may be drilled (e.g., established) from a base level using, for example, a drilling rig (not shown).

In certain exemplary embodiments, the base level may be established below ground level to locate a top of the base 10 or the base cap 112 supporting the wind turbine tower 11 at a predetermined level at or above grade level.

At the block 1320, base piles or drilled shaft piles 40 may be installed for each of the plurality of boreholes 56. For example, each of the plurality of drilled shaft piles 40 may be designed and installed to withstand axial compression and tension loading in combination with lateral shear and bending loading to sustain a design load threshold based on at least expected wind turbine generator loading.

At block 1330, an open trench 52 may be established (e.g., excavated) in the base level between two shaft piles 40. At block 1340 the open trench 52 may be filled with a mud slab or grout layer 60 to fill in the open trench 52 and may provide a flat and level base for the base cap 112. At the block 1340, the base cap 112 may be positioned on mud slab or grout layer 60 (e.g., that is a lower strength than a predetermined threshold strength level).

At the block 1350, the base cap 112 may be connected to each shaft pile 40 to support the wind turbine tower 11. For example, reinforcement inserts (e.g., rods, bars, or a mesh, among others) may be formed into reinforcement cages 42 and 45 and may be embedded into drilled shaft piles 40 and the base cap 112 using properly cast concrete.

The base cap 112 may be positioned relative to the plurality of drilled pile shafts 40 and connected to the plurality of drilled shaft piles 40 by properly casting concrete (e.g., premixed concrete) over reinforcements (e.g., steel reinforcements and/or reinforcement meshes) of the cylindrical cage 45 and the top of drilled shaft piles 40. Because hook-outs 46 of the drilled shaft piles 40 extend into the cylindrical cage 45, after the properly cast concrete cures, the plurality of drilled shaft piles 40 and the base cap 112 become integral (e.g., a single reinforced concrete base).

The method 1300 may include one or more of the following optional steps: (1) cleaning the site for excavation; (2) determining locations of the boreholes 56 (e.g., by surveying the construction site in accordance with a site plan); (3) surveying and marking a center point of the foundation 10 on the mud slab 60 for reference when positioning the reinforcement structures, the cable conduit 50 and/or the mounting plate 132; (4) positioning the embedded mounting plate 133 seated above the mud slab 60 (e.g., 6 inches to 14 above the mud slab) and supported by concrete blocks; (5) positioning shear bars 122 crossing the embedded mounting plate 133 and supporting the shear bars 122 by bar chairs; (6) placing outer bent bars 26 and inner bent bars 27 at specified positions such that straight surface bars 28 may weave through the pre-positioned shear bars 122; and (7) tying the conduit hangers 54 to either outer bent bars 26 or inner bent bars 27 as may be convenient (or use less materials).

The method 1300 may also include one or more of the following optional steps: (1) tying straight surface bars 28 to the upper ends of the corresponding outer bent bars 26 and inner bent bars 27 such that the overlap splice length for bar connection may follow American Concrete Institute (ACI) 318-08 (or new and/or other applicable governmental or industry standards or codes, among others); (2) attaching the anchoring bolts 130 to the mounting plate 132 and the embedded mounting plate 133 using hex nuts 141 on upper and lower sides of the anchoring bolts 130; (2) placing plastic bolt sleeves over the anchoring bolts 130 to isolate the anchoring bolts 130 from the concrete to permit post-tensioning of the anchoring bolts 130 after the wind turbine tower 11 is attached; (3) placing a temporary spacer around upper ends of the anchoring bolts 130 and attaching using hex nuts 141 to hold the anchoring bolts 130 in proper position during placement of the structural concrete; (4) placing the concrete for the base cap 112 without interruption; (5) removing the temporary spacer and hex nuts 141 from the exposed ends of the anchoring bolts 130 and forming high strength grout on the upper surface of the base cap 112; and/or (5) after the concrete in the base cap 112 has gained sufficient strength, erecting the wind turbine tower 11.

Although many optional steps are illustrated for the exemplary method 1300, it is contemplated that many different variations of this exemplary method 1300 may be used including implementing the method with fewer steps and/or implementing steps in different orders. For example the exemplary method may be adjusted for foundations based on variations due to different soil conditions or different standards of construction.

In certain exemplary embodiments, a monitoring device may be installed at the base cap for monitoring one or more of: (1) tilt of the base cap; (2) vibration frequency of the base cap; (3) displacement of the base cap; (4) velocity of the base cap; or (4) acceleration of the base cap to monitor the foundation 10 in real time during at least operation of the wind turbine.

The monitoring device may be embedded in the foundation 10, for example, at the top of the base cap 112, although other locations are also possible. The monitoring device may be linked to the automatic SCADA (Supervisory Control and Data Acquisition) system in a central control unit. The monitoring device may record the behavior of the base 10 continuously and may send warning signals automatically if the foundation 10 experiences a monitored quantity (e.g., tilt, movement, vibration, and/or acceleration, among others) over a predetermined or programmed tolerance threshold.

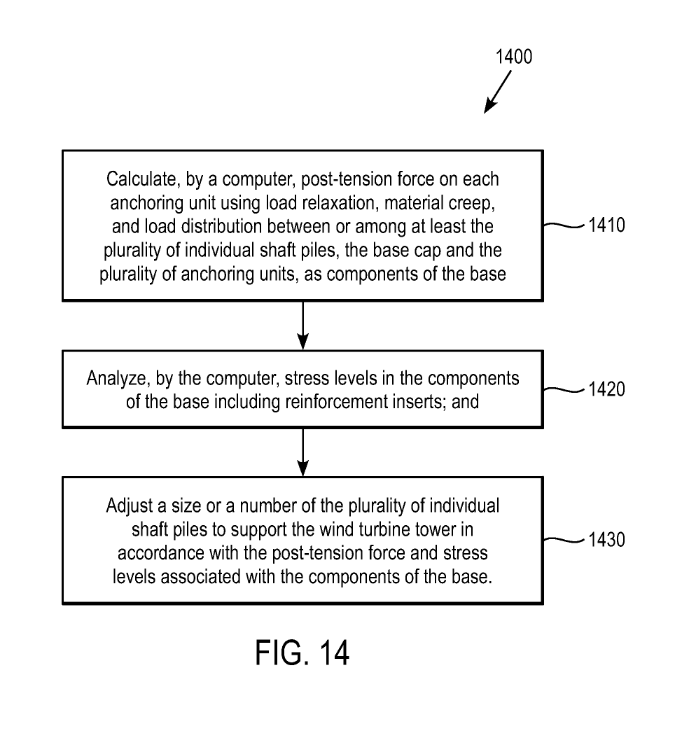

FIG. 14 is a flow chart illustrating a method 1400 of modeling behaviors of the base 10 for the wind turbine tower 11 in accordance with an exemplary embodiment of the invention.

Referring to FIG. 14, the method 1400 may be computer-implemented and may use a computer 600 to model behaviors of the base 10 for the wind turbine tower 11. At the block 1410, the computer 600 may calculate post-tension force on each anchoring unit 410 or 510 using load relaxation, material creep, and load distribution between or among at least the plurality of shaft piles 40 (e.g., individual shaft piles), the base cap 112 and the plurality of anchoring units 510, as components of the base 10.

At block 1420, the computer 600 may analyze stress levels in the components of the base 10 including reinforcement inserts of the base 10. At block 1430, a size and/or a number of the plurality of shaft piles (e.g., individual shaft piles) 40 are adjusted to support the wind turbine tower 11 in accordance with post-tension force and stress levels associated with components of the base 10. For example, one or more of: a size or a dimension of drilled shaft piles may be optimized for construction of shaft piles 40 by analyzing soil-structure-interaction in consideration of soil resistance associated with the drilled shaft piles 40.

In various exemplary embodiments, computer-aided design methods may be used to optimize each foundation system prior to construction based on site specific (e.g., unique subsurface conditions at the construction site) and/or building code specific loading (e.g., loading requirements). Costs of the foundation (or base) system may be significantly reduced by optimizing penetration of drilled shaft piles and the spacing between (and/or number of) drilled shaft piles. The foundation system may be installed in any types of soil/rock formations.

The numbers of foundation shafts may be varied in number to be sufficient to sustain the design load and/or stiffness (e.g., maximum design load and/or stiffness requirements) of the wind turbine generator foundation. The drilled shaft piles may be designed to withstand the axial compression and/or tension loading in combination with lateral shear and/or bending loading (e.g., lateral shear and bending loading required) to sustain the design loads of the foundation as dictated by (in accordance with) the wind turbine generator loading (e.g., loading requirements) and/or local building code (e.g., code requirements).

In certain exemplary embodiments, the calculation of post-tension force on each anchoring unit and the analysis of stress levels in the components of the base may include creating a 3-dimensional finite-element mode and presenting meshes for the base cap in regions corresponding to the plurality of anchoring units to model behaviors: (1) of the components of the base including reinforcement inserts; and (2) of the interfaces between components of the base.

In various exemplary embodiments, a bar element in the 3-dimensional finite-element model may be created and may be used to model steel bars and interface elements.

In certain exemplary embodiments, the calculating and analyzing steps may be repeated until the base 10 for holding the wind turbine tower 11 is sufficient to support the wind turbine tower 11 under pre-established wind loading conditions or under conditions establish based on an expected location of the wind turbine tower 11.

Although exemplary embodiments have been described in terms of a modeling method to model the foundation or base design, it is contemplated that it may be implemented in software on microprocessors/general purpose computers. In various embodiments, one or more of the functions of the various components may be implemented in software that controls a general purpose computer. This software may be embodied in a tangible, non-transitory computer storage medium, for example, a magnetic or optical disk, or memory card.

In addition, although the invention is illustrated and described herein with reference to specific embodiments, the invention is not intended to be limited to the details shown. Rather, various modifications may be made within the scope and range of equivalents of the claims and without departing from the invention.

What is claimed is:

1. A base for holding a wind turbine tower, comprising:
a plurality of individual shaft piles;
a base cap connected to each of the individual shaft piles, the base cap including a plurality of reinforcement inserts in the base cap for reinforcing the base cap; and
a plurality of anchoring units embedded in the base cap and extending in an anchoring direction from the base cap at anchoring locations for anchoring the wind turbine tower to the base cap such that each of the reinforcement inserts extend in a radial direction relative to a center axis of the wind turbine tower and at least one of the plurality of reinforcement inserts, at a radius of the center axis adjacent to an anchoring location of a respective anchoring unit, has a portion of the respective reinforcement insert extending along the anchoring direction.

2. The base of claim 1, wherein each respective individual shaft pile includes one of: (1) a spiral shaped reinforcement insert extending in a first direction; or (2) a tied transverse reinforcement extending in the first direction of the respective individual shaft pile.

3. The base of claim 2, wherein:
the spiral shaped reinforcement insert of the respective individual shaft pile includes a spiral pitch that varies in the first direction such that the pitch at a top portion of each respective individual shaft pile is less than a pitch at a bottom portion of the respective individual shaft pile; or
the tied transverse reinforcement includes a tie spacing that varies in the first direction of the respective individual shaft pile such that the tie spacing at a top portion of each respective individual shaft pile is less than the tie spacing at a bottom portion of the respective individual shaft pile.

4. The base of claim 1, wherein the at least one reinforcement insert is a plurality of reinforcement inserts that are each disposed extending in the radial direction.

5. The base of claim 4, wherein the anchoring locations define a circumference associated with the center axis such that each of the plurality of reinforcement inserts are disposed to extend in the radial direction across the circumference defined by the anchoring locations.

6. The base of claim 5, wherein each respective reinforcement insert of the plurality of reinforcement inserts is symmetric relative to a plane extending orthogonal to the radial direction that includes a crossing point of the respective reinforcement insert with the circumference defined by the anchoring locations.

7. The base of claim 4, wherein the plurality of reinforcement inserts are spaced apart at substantially equal angular positions relative to the center axis.

8. The base of claim 4, wherein the base cap is formed from concrete and the plurality of reinforcement inserts are formed from metal bars such that the concrete and the metal bars generate a reinforced concrete base cap.

9. The base of claim 1, wherein each respective individual shaft pile includes a plurality of pile reinforcement inserts having a projecting portion that projects from the respective individual shaft pile, the projecting portion of each of the plurality of pile reinforcement inserts being embedded in the base cap to individually connect the base cap to the respective individual shaft pile.

10. The base of claim 1, wherein each of the plurality of pile reinforcement inserts is shaped such that a portion of each respective pile reinforcement insert extends in a direction orthogonal or substantially orthogonal to the anchoring direction and is structured to provide a rigid connection between the base cap and the respective individual shaft pile.

11. The base of claim 10, wherein each of the plurality of pile reinforcement inserts, as steel inserts, has a first portion that is embedded in a respective individual shaft pile and a second portion that is embedded in the base cap.

12. The base of claim 1, wherein each of the plurality of individual shaft piles extends in the anchoring direction or at battered angles from the base cap.

13. The base of claim 1, wherein the wind turbine tower is connected to the base cap via an anchoring plate that is one of: (1) integral with the wind turbine tower; or (2) fastened to the wind turbine tower such that the anchoring plate rigidly connects to the plurality of anchoring units to hold the wind turbine tower.

14. The base of claim 1, wherein:
the base cap is a circular reinforced-concrete cap to which a base of the wind turbine tower is surmounted; and
the plurality of individual shaft piles are circular reinforced concrete drilled shaft piles connected to the circular reinforced-concrete cap.

15. The base of claim 1, further comprising:
a grout layer disposed under the base cap; and
a conduit extending from the surmounted wind turbine tower and projecting from the base cap via a trench formed in the grout layers between two of the individual shaft piles.

16. A computer-implemented method of modeling behaviors of a base for a wind turbine tower, the base including a plurality of individual shaft piles, a base cap connected to each of the individual shaft piles, the base cap including a plurality of reinforcement inserts in the base cap for reinforcing the base cap, and a plurality of anchoring units embedded in the base cap and extending in an anchoring direction from the base cap at anchoring locations for anchoring the wind turbine tower to the base cap such that each of the reinforcement inserts extend in a radial direction relative to a center axis of the wind turbine tower and at least one of the plurality of reinforcement inserts, at a radius associated with the center axis and adjacent to an anchoring location of a respective anchoring unit, has a portion of the respective reinforcement insert extending along the anchoring direction, the method comprising the steps of:
calculating, by a computer, post-tension force on each anchoring unit using load relaxation, material creep, and load distribution between or among at least the plurality of individual shaft piles, the base cap and the plurality of anchoring units, as components of the base;
analyzing, by the computer, stress levels in the components of the base including reinforcement inserts; and
adjusting a size or a number of the plurality of individual shaft piles to support the wind turbine tower in accordance with the post-tension force and stress levels associated with the components of the base.

17. The method of claim 16, wherein the calculating and analyzing steps are repeated until the base for holding the wind turbine tower is sufficient to support the wind turbine tower under pre-established wind loading conditions or under conditions establish based on a location of the wind turbine tower.

18. The method of claim 16, wherein the calculating and analyzing include:
creating a 3-dimensional finite-element model; and
presenting meshes for the base cap in regions corresponding to the plurality of anchoring units.

19. The method of claim 18, wherein the creating of the 3-dimensional finite-element model includes modeling behaviors: (1) of the components of the base including the reinforcement inserts; and (2) interfaces between components of the base.

20. The method of claim 19, further comprising the steps of:
creating a bar element in the 3-dimensional finite-element model; and
modeling steel bars and interface elements using the created bar element.

21. The method of claim 16, further comprising the step of
optimizing one or more of: a size or a dimension of drilled shafts for construction of the individual shaft piles by analyzing soil-structure-interaction in consideration of soil resistance on the drilled shafts.

22. A method of constructing a base for a wind turbine tower, the method comprising the steps of:
drilling from a base level to establish a plurality of boreholes;
installing base piles for each of the plurality of boreholes;
establishing an open trench in the base level between two of the base piles;
filling at least the open trench with a mud slab;
positioning a base cap on the mud slab; and
connecting the base cap to each of the base piles to support the wind turbine tower.

23. The method of claim 22, further comprising the steps of:
laying a conduit in the open trench prior to the filling of the open trench with the mud slab, the conduit extending through a center opening in the base cap; and
pulling one or more cables through the laid conduit to electrically connect equipment on the wind turbine tower externally.

24. The method of claim 22, further comprising the step of
establishing the base level below grade level for locating a top of the base supporting the wind turbine tower at a predetermined level at or above grade level.

25. The method of claim 22, further comprising the steps of:
positioning an embedded anchoring plate on the mud slab;
bending, at a construction site, steel reinforcements to one or more predetermined shapes;
laying at least a portion of the bent steel reinforcements over the embedded anchoring plate for reinforcement of the base cap; and
properly casting concrete to faun the base cap, as a steel reinforced base cap, by embedding the laid steel reinforcements within the properly casted concrete.

26. The method of claim 22, further comprising the steps of:
placing different types of steel reinforcements around the embedded anchoring plate for surface and shear reinforcement, as a bar mesh;
bending and weaving steel reinforcements extending from the base piles into the bar mesh; and
embedding the bar mesh in properly casted concrete to form a steel reinforced base cap.

27. The method of claim 26, wherein the properly casted concrete is pre-mixed concrete that is used to fill the base cap.

28. The method of claim 22, further comprising the step of:
designing base piles to withstand axial compression and tension loading in combination with lateral shear and bending loading to sustain a design load threshold based on at least expected wind turbine generator loading.

29. The method of claim 22, further comprising the step of:
installing a monitoring device at the base cap for monitoring one or more of: (1) tilt of the base cap; (2) vibration frequency of the base cap; (3) displacement of the base cap; (4) velocity of the base cap; or (5) acceleration of the base cap.

30. A computer readable storage medium for storing program code executable on a computer to implement the method of modeling behaviors of a base for a wind turbine tower, the method comprising the steps of:
calculating post-tension force on each of a plurality of anchoring units using load relaxation, material creep, and load distribution between or among at least a plurality of individual shaft piles, a base cap and the plurality of anchoring units, as components of the base;
analyzing stress levels in the components of the base; and
adjusting a size or a number of the plurality of individual shaft piles to support the wind turbine tower in accordance with the post-tension force and stress levels associated with the components of the base.
